(19) United States
(12) Patent Application Publication
(10) Pub. No.: US 2013/0281298 A1
(43) Pub. Date: Oct. 24, 2013

(54) PLANT GROWTH ENHANCING MIXTURE

(71) Applicants: Albert Liptay, Houston, TX (US); Ronald Salzman, College Station, TX (US); Jerry H. Stoller, Houston, TX (US)

(72) Inventors: Albert Liptay, Houston, TX (US); Ronald Salzman, College Station, TX (US); Jerry H. Stoller, Houston, TX (US)

(73) Assignee: STOLLER ENTERPRISES, INC., Houston, TX (US)

(21) Appl. No.: 13/866,949

(22) Filed: Apr. 19, 2013

Related U.S. Application Data
(60) Provisional application No. 61/636,332, filed on Apr. 20, 2012.

(51) Int. Cl. A01N 43/16; A01N 43/08; A01N 43/90

(52) U.S. Cl. CPC A01N 43/16; A01N 43/90; A01N 43/08
USPC 504/136; 504/292

(57) ABSTRACT

Trehalose or trehalose-6-phosphate, when applied exogenously to citrus trees that are compromised in their growth and development with the condition referred to as citrus greening or HLB, can overcome the deadly effects of the problem. Renewal of tree tissue with trehalose or trehalose-6-phosphate has been documented to begin as soon as 72 hours after exogenous application to the dying tree. The tissue renewal continues with near complete renewal of the leaf canopy, development of fruiting buds, followed by flower development and then development of the flowers into abundant and healthy fruits. Much of what appeared to be dead wood tissue could be covered with healthy new leaves within 2 to 4 months after application. Addition of defined hormones to the soil application of trehalose or trehalose-6-phosphate further enhanced development of new canopy and root tissue.

This application claims the benefit of U.S. Provisional Application Ser. No. 61/636,332 filed Apr. 20, 2012, entitled “Plant Growth Enhancing Mixture.” Applicant incorporates by reference herein U.S. Provisional Application Ser. No. 61/636,332 in its entirety.

### BACKGROUND OF THE INVENTION

1. Field of the Invention

This invention relates to the signaling effect of the exogenously-applied non-reducing sugar trehalose in crop plants, in particular to the members of the citrus family of plants devastated by the globally-prevalent disease referred to as citrus greening or Huanglonbing (HLB or yellow dragon disease). This invention also relates to the signaling effect of other exogenously-applied non-reducing sugars or similar materials or metabolites, in particular to the members of the citrus family of plants devastated by the globally-prevalent disease referred to as citrus greening or HLB, and caused by the bacteria Candidatus Liberibacter, which is distributed by the Asian Citrus Psyllid, Diaphorina citri, causing phloem restriction in the citrus trees. This issue certainly elicits a huge plant hormone imbalance in the citrus tree.

2. Description of the Prior Art

There are underlying/concomitant disorders which can be abiotic or biotic that further exacerbate the citrus greening condition and general “health” of the tree, because of “easier” infection incited by the citrus greening condition. Moreover, it is also suggested that other bacteria on any other crop plants or other plants may succumb to similar or other forms of devastation of the plant hormone balance in plants with ensuing compromised growth and development. Likewise, even without bacterial infection, other trees or plants that simply lose optimal hormone balance, may decline as happens more rapidly with citrus greening but can and does happen with aging of organisms.

Conventionally crop plants have been grown mostly based on well-studied, state recommended fertility practices, with focus solely or mainly on supplying an abundance or over-abundance especially of the major minerals, nitrogen, phosphorus and potassium, and possibly other minerals. This approach although widespread throughout agricultural production can be counterproductive and moreover is an approach categorically misaligned with the overall biological realities of optimal gene expression by the plethora of signaling molecules (currently many unknown and many others of which there is more than likely acute unawareness of the potential for utilizing exogenously, well-known plant growth regulators for assisting the optimization of the hormone balance in the plant) that can be used for maximizing crop plant productivity. The antidote to the compromised issue in the case of citrus greening, i.e. misaligned hormone balance and metabolite signaling of crop development, is to exogenously apply those signaling metabolites and/or the regulating hormones to create an optimal balance of hormones, signaling or regulating molecules and optimal transfer and distribution of metabolites for growth and development of the whole of the crop plant.

The compromising features of plant growth and crop production by the “disease,” citrus greening, also referred to as HLB, leading to eventual death of the crop tree, appears to be a dysfunction of the photosynthate transfer system or “pipeline” referred to, anatomically in plant organisms, as the “phloem.” At least 2 major systems required for crop production signaling and “food” transfer are essentially first partially compromised and with ensuing death, are finally completely shut down. The first compromised aspect is the critical transfer of plant regulating hormones and metabolites for proper signaling of gene expression for growth and development.

This compromised transfer is both to the downward movement from the shoot tip to the root tip, as well as the upward movement from the root tips to the shoot tips, and also any lateral or other movement of these signaling or regulatory molecules. Moreover, the above then secondly results in congestion and clogging of transfer of photosynthates from the leaves or other sites of photosynthesizing chloroplasts, with concomitant excessive build-up of sugars into apparently non-mobile starch in the leaves, thus further deteriorating transfer of sugars and other metabolites that are absolutely crucial for proper growth and development of the crop plant. The overall result of the above lack of this functionality is a slow and tortuous death of the crop plant.

3. Identification of the Objects of the Invention

One object of the invention is to provide a chemical composition or mixture that stimulates more efficient synthesis and abundant transfer of regulating hormones and/or signaling metabolites for optimal or even maximal regulation of gene expression for enhanced productivity of the whole plant from the tips of the shoots to the tips of the roots and from the root tips and laterally to cover all relevant tissues of the growing crop plant.

Another object of the invention is to provide a chemical composition or mixture that stimulates more efficient and abundant transfer of sugars, amino acids and other photosynthates from site(s) of synthesis of the metabolites to the tissue sites wherein these molecules are required for growth and development of the crop, especially when it is in a compromised condition as with citrus greening.

Another object of the invention is to provide a chemical composition or mixture that stimulates development of new tissues throughout the crop plant to replace the tissues that are dysfunctional.

Another object of the invention is to provide a chemical composition or mixture that stimulates development of new tissues throughout the crop plant to replace the tissues that are dysfunctional, because of disruption of hormone and signaling molecule balance over the whole plant, by this or any other bacteria or organism causing disease or by any other stress or other factor resulting in compromised tissues in crop plants.

Another object of the invention is to provide a chemical composition or mixture that enhances cell division and cell differentiation and hence development of new “transfer tissue” pipelines, referred to in plant science as vascular tissue, encompassing phloem, xylem extracellular spaces and other related tissue for transfer of regulating hormone and signaling molecule for development of new and all relevant tissues in the crop plant.

Another object of the invention is to provide a method of applying exogenous signaling molecules and/or exogenous regulating hormones to “restart” the compromised and slowly dying crop plant to develop new tissues throughout the crop plant to renew synthesis and transfer of regulating hormones and signaling molecules for normal and optimal growth and development of the crop plant.

Another object of the invention is to provide a method of applying exogenous signaling molecules and/or exogenous regulating hormones to not only “restart” the compromised and slowly dying crop plant but also to develop new tissues throughout the crop plant to renew synthesis and transfer of regulating hormones and signaling molecules for normal and optimal growth and development of the crop plant, and also to continue synthesis and transfer of these molecules for continued “healthy” growth, over a relatively long and productive life span.

Another object of the invention is to provide a method of applying exogenous signaling molecules and/or exogenous regulating hormones to not only “restart” the compromised and slowly dying crop plant to develop new tissues throughout the crop plant to renew synthesis and transfer of regulating hormones and signaling molecules for normal and optimal growth and development of the crop plant, but also to continue synthesis and transfer of these molecules for continued “healthy” growth, over a relatively long and productive life span, by unclogging the previously citrus greening compromised tissues and through autophagy and/or other means, recycle and use the metabolic materials that were in a compromised pattern formerly for new and effective tissue growth.

Another object of the invention is to provide a method of continued intermittent application (twice per year) of exogenous signaling molecules and/or exogenous regulating hormones to not only “restart” the compromised and slowly dying crop plant to develop new tissues throughout the crop plant to renew synthesis and transfer of regulating hormones and signaling molecules for normal and optimal growth and development of the crop plant, but also to continue synthesis and transfer of these molecules for continued “healthy” growth, over a relatively long and productive life span, by unclogging the previously citrus greening compromised tissues and through autophagy and/or other means, recycle and use the metabolic materials that were in a compromised pattern formerly, for further development of new and functional tissues.

### BRIEF DESCRIPTION OF THE DRAWINGS

By way of illustration and not limitation, the invention is described in detail hereinafter on the basis of the accompanying figures, depicting the result of applying trehalose to the leaf canopy or to the leaf canopy and the bottom of the tree trunk leading to the roots in the soil with the growth hormone regulators and/or other molecules and/or minerals.

FIG. 1 illustrates the condition of an orange tree before foliar trehalose application;

FIG. 2 illustrates the condition of tree from FIG. 1 on Mar. 22, 2012, that was treated with Trehalose on Nov. 30, 2011 with a nearly complete renewal of the tree four months after one foliar treatment to the canopy of leaves;

FIG. 3 illustrates new leaves that are formed even on apparently dead branches as late as four months after treatment;

FIG. 4 illustrates a close-up of new leaf growth on apparently dead branches even four months after treatment of tree seriously afflicted with citrus greening;

FIG. 5 illustrates a prolific development of flowers of the tree shown in FIGS. 1 and 2 three months after treatment;

FIG. 6 illustrates another tree treated with foliar trehalose and also with trehalose and a hormone mixture by drenching the bottom of the trunk of the citrus tree and allowing the rest of chemical mixture to flow into the soil and unto the roots at the crown of the plant;

FIG. 7 illustrates three new leaves on a little branch that 72 hours earlier appeared to be dead, of the treated tree as in FIG. 6;

FIG. 8 illustrates a new leaf at the end of the little branch 72 hours after treatment as in FIG. 6;

FIG. 9a illustrates fruit load on an orange tree 12 months after treatment;

FIG. 9b illustrates fruit load on the orange tree 14 months after treatment; and

FIG. 9c illustrates the pristine condition of the new leaves of the tree of FIG. 9b.

### SUMMARY OF THE INVENTION

The objects identified above, along with other features and advantages of the invention are incorporated in a plant growth enhancing mixture comprising at least the signaling molecule trehalose, preferably trehalose or trehalose-6-phosphate, or other compound(s) eliciting similar effects to the two listed compounds, to transfer photosynthates to new developing plant tissue.

This invention relates to the signaling effect of the exogenously-applied non-reducing sugar trehalose in crop plants, in this particular case to the members of the citrus family of plants devastated by the globally-prevalent disease referred to as citrus greening or Huanglonbing (HLB or yellow dragon disease). The invention also relates to the signaling effect of other exogenously-applied non-reducing sugars or similar materials or metabolites, in this particular case to the members of the citrus family of plants devastated by the globally-prevalent disease referred to as citrus greening or HLB, and caused by the bacteria Candidatus Liberibacter, which is distributed by the Asian Citrus Psyllid, Diaphorinacitri, causing phloem restriction in the citrus trees. This issue certainly elicits a huge plant hormone imbalance in the citrus tree. There are underlying concomitant disorders which can be abiotic or biotic that further exacerbate the citrus greening condition and general “health” of the tree because of “easier” infection incited by the citrus greening condition. Moreover, it is also suggested that other bacteria on any other crop plants or other plants may succumb to similar or other forms of devastation of the plant hormone balance in plants with ensuing compromised growth and development. Likewise, even without bacterial infection, other trees or plants that simply lose optimal hormone balance, may decline as happens more rapidly with citrus greening but can and does happen with aging of organisms.

### DESCRIPTION OF EMBODIMENTS OF THE INVENTION

In a preferred application for a foliar application to the canopy of leaves of the affected citrus trees, of trehalose or trehalose-6-phosphate, in an aqueous solution of concentrations ranging from 0.0002% to 2% in a volume of 100 gallons of water per acre, with a preferred percentage of 0.02% in said 100 gallons of water per acre. With a preferred percentage of 0.02% in said 100 gallons of water per acre, other plant hormones such as cytokinin and gibberellin may be added to further enhance development of new tissue, but not necessarily limited to cytokinin and gibberellin.

The plant growth enhancing mixture has been observed to greatly enhance the nutrition and development of the plant by massive cell division and cell differentiation instigated by trehalose and further enhanced depending on the concomitant disorders or disease affecting the trees by the citrus greening disorder, by hormones such as cytokinin and gibberellin but not limited or restricted to these hormones in a competent epigenetic fashion, and resulting in sturdier and healthier and more productive economic portions of the crop plant.

In a preferred application for a soil application to the bottom of the trunk of the affected trees with any excess dripping into the soil and unto the roots of the affected citrus trees, of trehalose or trehalose-6-phosphate, an aqueous solution of concentrations ranging from 0.0002% to 2% in a volume of 100 gallons of water per acre, with a preferred percentage of 0.02%.

In still a further preferred application for a soil application to the bottom of the trunk of the affected trees with any excess dripping in to the soil and unto the roots of the affected citrus trees, of trehalose or trehalose-6-phosphate, an aqueous solution of concentrations ranging from 0.0002% to 2% in a volume of 100 gallons of water per acre, with a preferred percentage of 0.02% of trehalose or trehalose-6-phosphate with other plant hormones such as cytokinin and gibberellin to further enhance development of new tissue, but not necessarily limited to cytokinin and gibberellin. The signaling molecules Trehalose or Trehalose-6-Phosphate are preferably applied to the plants in an aqueous solution with or without other components such as the minerals cobalt or manganese which in combination with trehalose or tehalose-6-phosphate suppress the deleterious effects of ethylene, present when crop plants suffer from biotic or abiotic stress conditions such as high temperatures, water deficit etc.

The plant growth enhancing mixture has been observed to greatly enhance the nutrition and development of the plant by massive cell division and cell differentiation instigated by hormones such as cytokinin and gibberellin but not limited or restricted to these hormones, and resulted in sturdier and healthier and more productive economic portions of the crop plant

The plant growth enhancing mixture has been observed to greatly enhance the nutrition and development of the massive cell division and cell differentiation instigated by hormones such as cytokinin and gibberellin but not limited or restricted to these hormones, and resulted in sturdier and healthier and more productive economic portions of the crop plant, and especially enhanced the sugar transfer use and efficiency of the crop plant and resulting in rather large increases in crop productivity.

The plant growth enhancing mixture has been observed to greatly increase the development of fruiting buds with subsequent floral development of the fruiting buds and then into abundant and healthy fruit produce.

The plant growth enhancing mixture has been observed to greatly increase the amount of harvestable yield of crop plants without evidence of the former compromised growth of the citrus trees and citrus fruit production.

The plant growth enhancing mixture has been observed to overcome the citrus greening disabled phenotype by forming a new healthy canopy and root system and greatly increasing the amount of harvestable yield of crop plants, by application of the signaling reducing sugar trehalose, but not limited to trehalose either as a foliar spray to the apparent dying limbs, remains of leaves and buds in at least 100 gallons of water per acre. It is imperative that coverage of the dying tree by the mixture be as complete as possible. A “soil” drench as indicated earlier can further assist in difficult situations complicated by other disorders than citrus greening whether abiotic or biotic.

In a preferred implementation for a soil application or a tree trunk application of trehalose with sufficient material to enter to the soil roots, a chemical composition or mixture of the plant growth enhancing mixture comprises an aqueous blend of two plant hormones-cytokinin and gibberellin or as a foliar application to the “above ground” portion of the tree as indicated earlier. As is well known to those skilled in the art, cytokinin and gibberellin may be obtained from various natural sources or they may be chemically synthesized. The gibberellin is preferably selected from one or more of the following: GA₁, GA₂, GA₃, GA₄, GA₅, GA₆, GA₇, GA₈, GA₉, GA₁₀, GA₁₁, GA₁₂, GA₁₃, GA₁₄, GA₁₅, GA₁₆, GA₁₇, GA₁₈, GA₁₉, GA₂₀, GA₂₁, GA₂₂, GA₂₃, GA₂₄, GA₂₅, GA₇₆, GA₂₇, GA₂₈, GA₂₉, GA₃₀, GA₃₁, GA₃₂, GA₃₃, GA₃₄, GA₃₅, GA₃₆, GA₃₇, GA₃₈, GA₃₉, GA₄₀, GA₄₁, GA₄₂, GA₄₃, GA₄₄, GA₄₅, GA₄₆, GA₄₇, GA₄₈, GA₄₉, GA₅₀, GA₅₁, GA₅₂, GA₅₃, GA₄, GA₅₅, GA₅₆, GA₅₇, GA₅₈, GA₅₉, GA₆₀, GA₆₁, GA₆₂, GA₆₃, GA₆₄, GA₆₅, GA₆₆, GA₆₇, GA₆₈, GA₆₉, GA₇₀, GA₇₁, GA₇₂, GA₇₃, GA₇₄, GA₇₅, GA₇₆, GA₇₇, GA₇₈, GA₇₉, GA₈₀, GA₈₁, GA₈₂, GA₈₃, GA₈₄, GA₈₅, GA₈₆, GA₈₇, GA₈₈, GA₈₉, GA₉₀, GA₉₁, GA₉₂, GA₉₃, GA₉₄, GA₉₅, GA₉₆, GA₉₇, GA₉₈, GA₉₉, GA₁₀₀, GA₁₀₁, GA₁₀₂, GA₁₀₃, GA₁₀₄, GA₁₀₅, GA₁₀₆, GA₁₀₇, GA₁₀₈, GA₁₀₉, GA₁₁₀, GA₁₁₁, GA₁₁₂, GA₁₁₃, GA₁₁₄, GA₁₁₅, GA₁₁₆, GA₁₁₇, GA₁₁₈, GA₁₁₉, GA₁₂₀, GA₁₂₁, GA₁₂₂, GA₁₂₃, GA₁₂₄, GA₁₂₅, GA₁₂₆. The cytokinin is selected from one or more of the following: zeatin, various forms of zeatin, N6-benzyl adenine, N6-(delta-2-isopentyl) adenine, 1,3-diphenyl urea, thidiazuron, CPPU (forchlorfenuron), kinetin or other chemical formulations with cytokinin activity.

The preferred gibberellin is the gibberellic acid, GA₃, and is present in the aqueous mixture in an amount such that the GA₃ is between about 0.1 to 10 percent by weight, more preferably between about 0.5 to about 5 percent by weight and most preferably between about 0.075 to about 0.125 percent by weight. The preferred cytokinin is kinetin and is present in the aqueous mixture in an amount such that the kinetin is between about 0.003 to 0.3 percent by weight, more preferably between about 0.0015 to 0.15 percent by weight and most preferably between about 0.01 to 0.05 percent by weight.

The ratio of the plant hormones, cytokinin and gibberellin, preferably ranges from 1:10 to 1:300 and more preferably from 1:20 to 1:40. A ratio of approximately 1:30 is most preferable. Nonetheless, to obtain the best results, the absolute amount of the cytokinins and gibberellins must vary proportionally to the volume/weight of the treated plants and their fruit. The absolute amount of the cytokinins preferably varies between 1 to 300 mg per hectare of growing plants, but more preferably between 20 to 80 mg per hectare of growing plants. The absolute amount of the gibberellins preferably varies between 100 to 10,000 mg per hectare of growing plants, but more preferably between 500 to 2,500 mg per hectare of growing plants.

### EXAMPLES

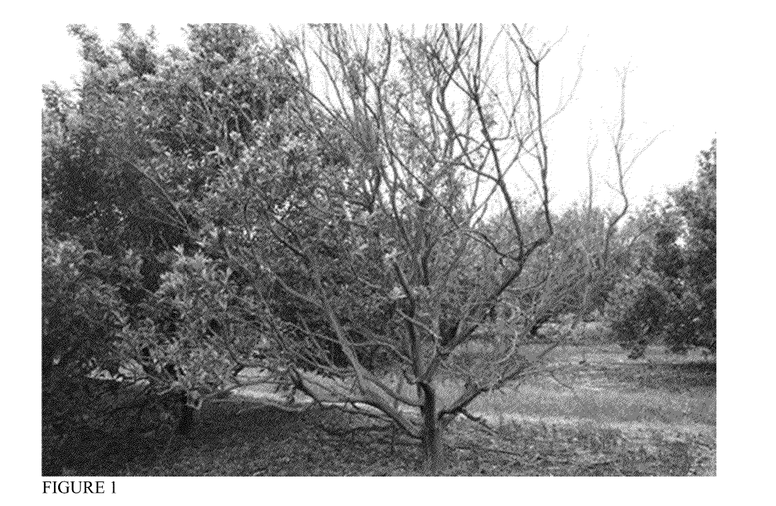

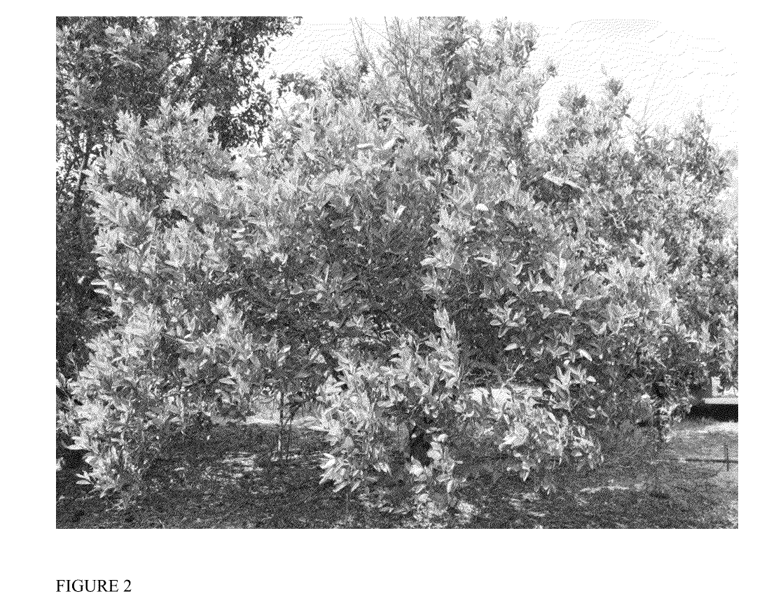

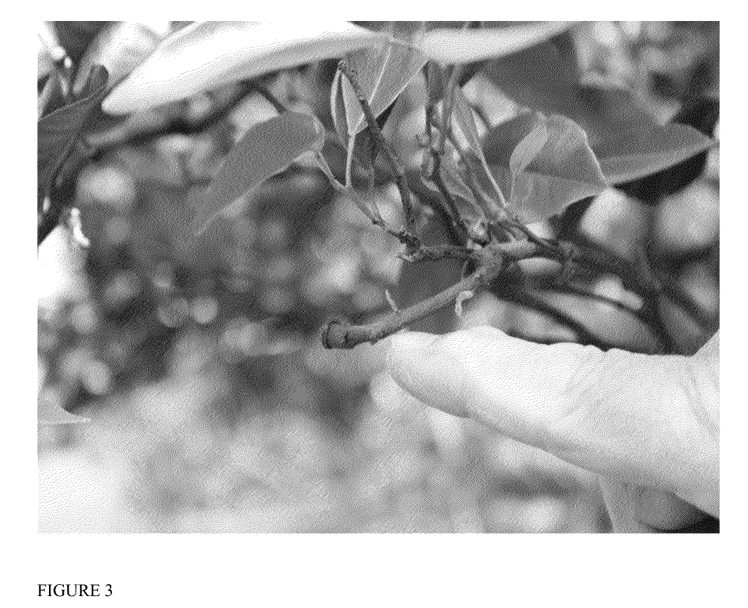

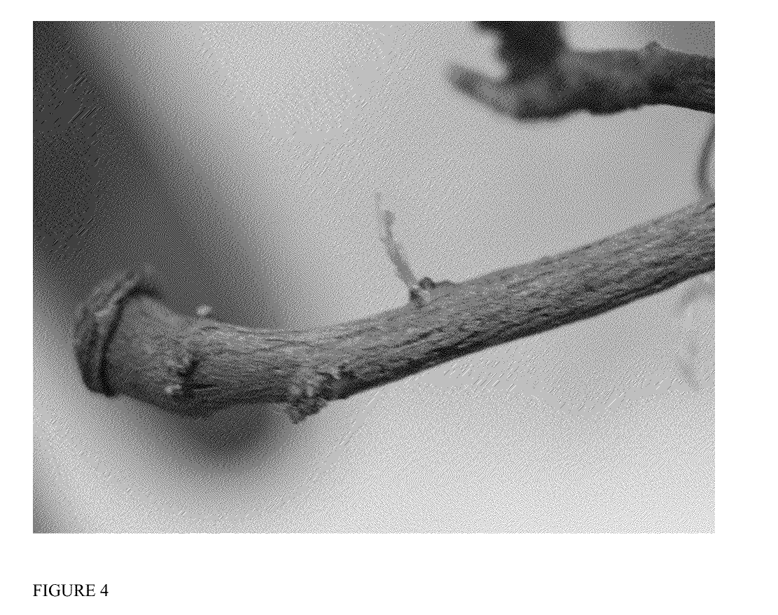

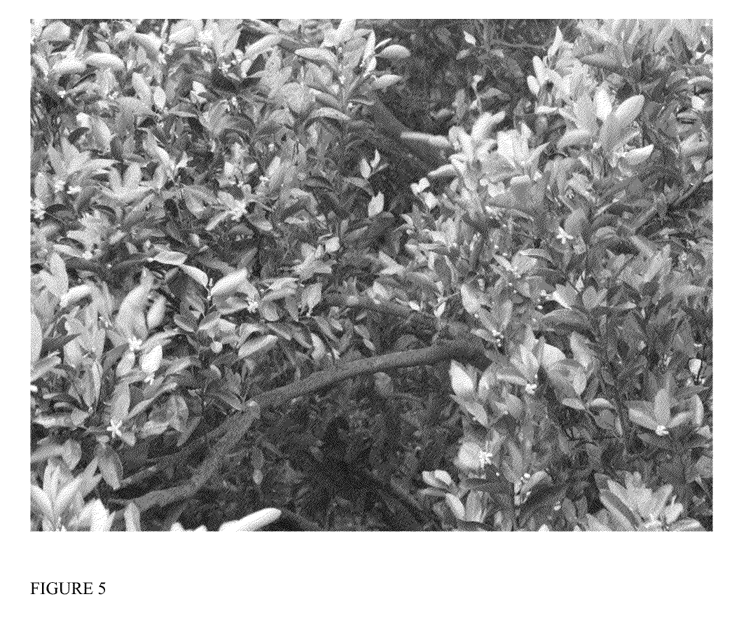

The figures show several examples of the results of applying the plant growth enhancing mixtures to citrus trees and plants. For example, FIGS. 1 and 2 show the condition of an orange tree before and after foliar trehalose application, respectively. In the example shown in FIGS. 1 and 2 an aqueous solution was prepared by combining trehalose with water at a concentration of 1 gram trehalose per 1 gallon of water. Thereafter, the aqueous solution was applied to the foliage of citrus trees at a rate of 100 gallons/acre. FIG. 2 shows the tree four months after a single treatment with the aqueous solution. FIG. 3 illustrates new leaves that are formed even on apparently dead branches as late as four months after treatment. FIG. 4 illustrates a close-up of new leaf growth on apparently dead branches even four months after treatment of tree seriously afflicted with citrus greening. Similarly, FIG. 5 shows the same tree three months after the single application with the aqueous solution, while the tree was flowering.

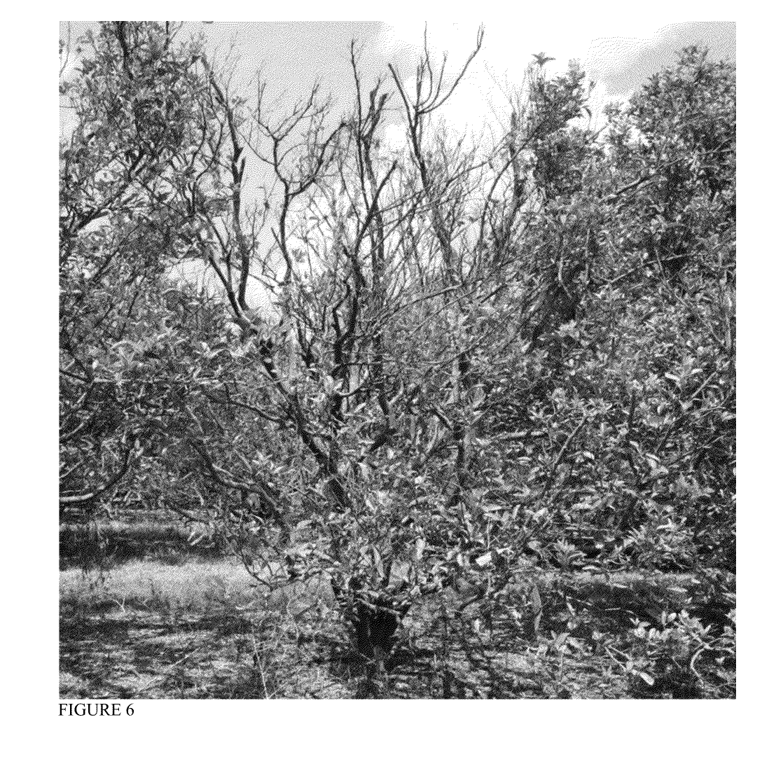

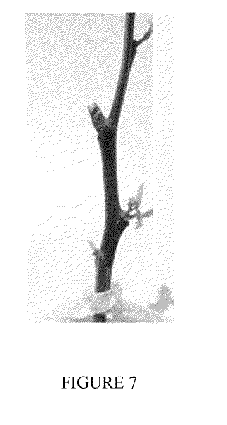

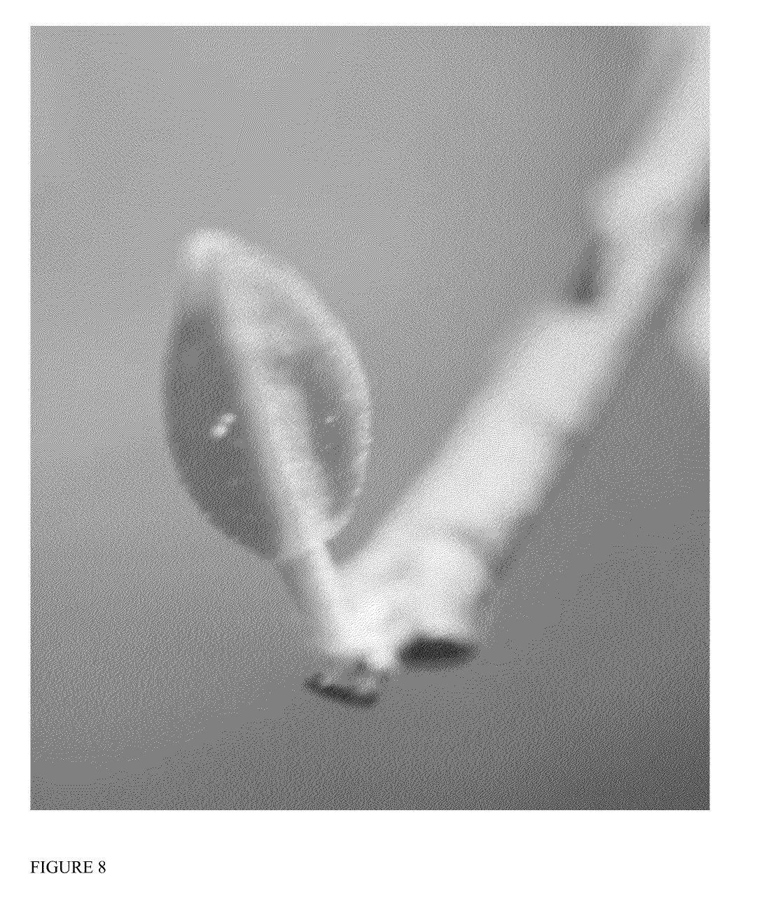

FIGS. 6-8 show another example of the results of applying an aqueous solution according to an embodiment of the present invention. For example, FIG. 6 shows a tree that has been treated with a solution containing 1 gram of trehalose per 1 gallon of water, as well as the plant hormones cytokinin and gibberellin. The cytokinin made up about 0.0015 weight percent of the solution, while the gibberellin made up about 0.5 weight percent of the solution. In this example, the aqueous solution was applied to the soil immediately at the base of the tree around the trunk at a rate of 1 gallon per tree. The solution was then drenched into the ground. FIGS. 7 and 8 show new leaves appearing on a branch that previously appeared to be dead, about 72 hours after application of the solution.

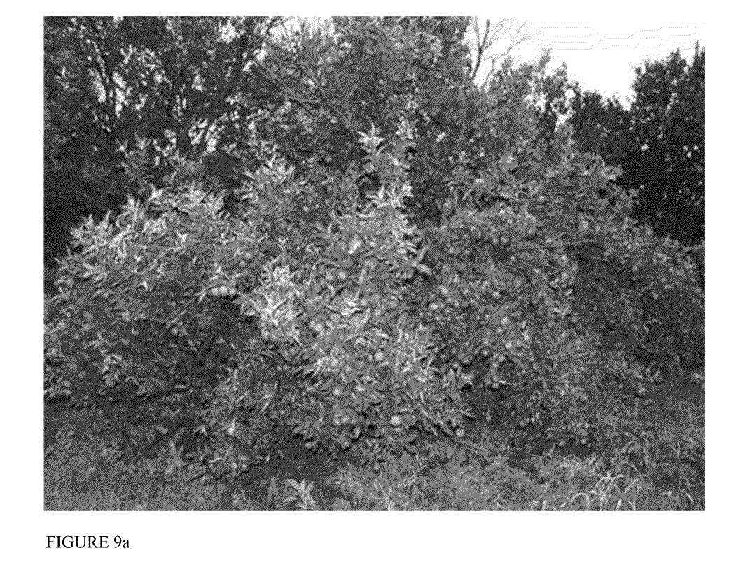

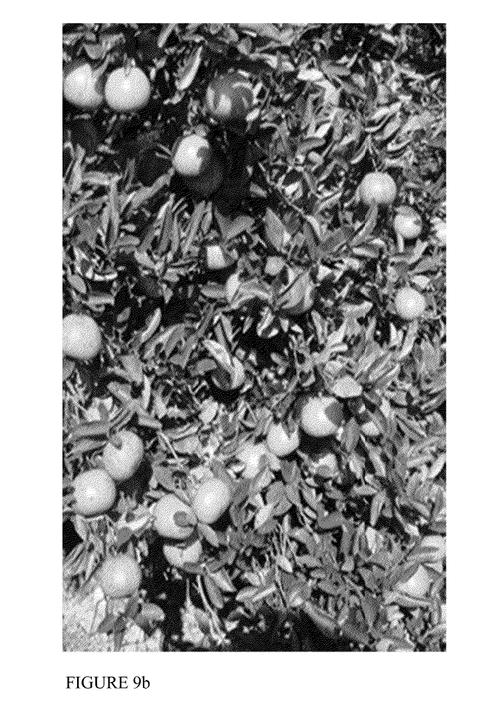

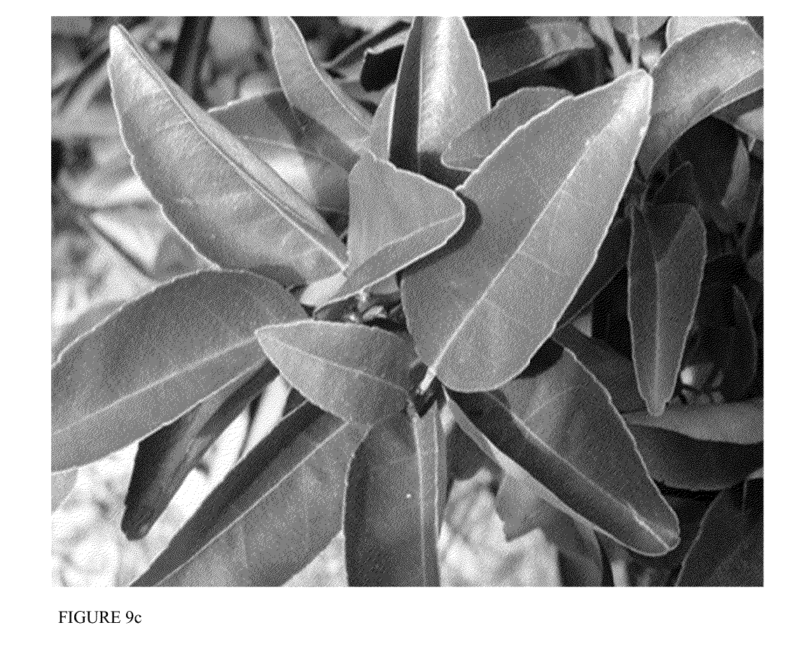

FIG. 9a illustrates fruit load on an orange tree 12 months after treatment;

FIG. 9b illustrates fruit load on the orange tree 14 months after treatment; and

FIG. 9c illustrates the pristine condition of the new leaves of the tree of FIG. 9b.

The visual appearance of the leaves and fruits of treated trees show the absence of the causal organism of citrus greening, HLB. The absence of that organism is also demonstrated by a molecular biology technique for determining real-time-PCR, Cₜ values. Cₜ values in the forty's are found in the treated trees, where Cₜ values in the twenties are found in infected trees.

What is claimed is:

1. A method for enhancing the growth of plants, the method comprising the steps of:
mixing an aqueous solution including trehalose or trehalose-6-phosphate, and applying the aqueous solution to citrus greening-affected trees.

2. The method of claim 1,
wherein the aqueous solution is applied to the canopy of leaves of the trees.

3. The method of claim 1, wherein
the aqueous solution is applied to the root system of the trees.

4. The method of claim 1, wherein
the aqueous solution is applied to the bottom of the trunks of the trees so that the aqueous solution leaches into the root system of the trees.

5. A plant growth enhancing mixture comprising:
an aqueous solution including trehalose or trehalose-6-phosphate.

6. The plant growth enhancing mixture of claim 5, wherein the aqueous solution further comprises,
a cytokinin and gibberellin.

7. The plant growth enhancing mixture of claim 5, wherein the aqueous solution further comprises,
a plurality of plant hormones including at least a cytokinin and gibberellin.

8. The plant growth enhancing mixture of claim 6, wherein
the aqueous solution includes between about 0.003 to about 0.3 weight percent cytokinin, and between about 0.1 to about 10 weight percent gibberellin.

9. The plant growth enhancing mixture of claim 6, wherein
the aqueous solution includes between about 0.0015 and about 0.15 weight percent cytokinin, and between about 0.5 and about 5 weight percent gibberellin.
